(19) United States
(12) Patent Application Publication
(10) Pub. No.: US 2009/0177716 A1
(43) Pub. Date: Jul. 9, 2009

(54) REMOVABLE STORAGE DEVICE AND ELECTRONIC APPARATUS THAT CAN BE CONNECTED TOGETHER AND METHOD FOR SAVING ENVIRONMENTAL DATA

(75) Inventor: Marc Bertin, La Celle Les Bordes (FR)

Correspondence Address: YOUNG & THOMPSON, 209 Madison Street, Suite 500, ALEXANDRIA, VA, 22314, US

(73) Assignee: OBERTHUR TECHNOLOGIES, PARIS (FR)

(21) Appl. No.: 12/305,116

(22) PCT Filed: Jun. 13, 2007
(86) PCT No.: PCT/FR2007/000981

§ 371 Date: Dec. 16, 2008

(30) Foreign Application Priority Data
Jun. 16, 2006 (FR) 0652154

(51) Int. Cl. G06F 12/16; G06F 17/30

(52) U.S. Cl. 707/204; 707/E17.005

(57) ABSTRACT

A removable electronic storage device (130) can be connected to an electronic apparatus having a microprocessor and an element for storing environmental data. This device includes a program (131) that can be executed automatically by the microprocessor of the apparatus on connecting the device (130) to the apparatus so as to allow the saving of the environmental data within the device (130).

The invention concerns a removable storage device and electronic apparatus that can be connected together and a method of saving environmental data.

Electronic apparatus that manipulates digital data, for example a cellular telephone, generally stores in storage means (such as a rewritable non-volatile memory) data specific to the usual user of the apparatus, generally lumped together under the term “environment” and referred to hereinafter as environment data. This includes data frequently used by the user (such as the names and telephone numbers constituting the telephone directory stored by the apparatus), configuration data that determines some operating parameters of the apparatus, or other data associated with the user (for example data representing the picture chosen by the user as the wallpaper for their apparatus).

Users naturally wish to be able to retain this data when using apparatus other than that in which it is stored and to this end systems have been proposed for backing-up this data with the aim of recovering it in other apparatus, if possible.

In this context, patent application FR 2 863 443 proposes to back up the information stored in a mobile telephone in a back-up unit external to the telephone.

In the same line of thinking, patent application DE 101 46 664 teaches backing-up user data either in a remote computer or in a removable memory card. This document teaches associating possibly the removable memory card with the system for charging the battery of the telephone in order to trigger automatic backing up of the data when the user connects the telephone to the charging system.

However, the above systems store environment data only if the electronic apparatus is specifically designed to do this.

Given this background, the invention proposes a removable storage electronic device adapted to be connected to an electronic apparatus including a microprocessor and means for storing environment data, characterized in that it includes a program adapted to be executed automatically by the microprocessor on connection of the device to the apparatus in order to enable backing up of the environment data in the device.

Backing-up is therefore effected without necessitating a particular action of the user and even if the electronic apparatus does not contain the backing-up program.

The removable storage electronic device (or removable information medium) can be an information medium with no processing capacity (for example a diskette, a magnetic or optical smart card) or an information medium with processing capacity (such as a Flash memory or a microcontroller-based microcircuit card). The electronic storage device can also be a USB key, an MMC card or an SD card.

The electronic apparatus is portable, for example. It can be a mobile telephone, a personal digital assistant (PDA) or a USB (Universal Serial Bus) key.

The environment data that is backed up can include personal data (such as data representing a telephone directory, a diary, digital photographs or videos, messages sent or received by the user), configuration data (for example defining ringtones of the electronic apparatus, security parameters or parameters authorizing access to certain services) or application data (such as computer programs).

The connection is made, for example, on inserting the device into a reader of the apparatus or on inserting a connector of the device into an appropriate connector of the apparatus.

The storage device can also store a list indicating the environment data to be backed up, enabling the environment to be backed up completely.

The program (when it is executed by the microprocessor) can nevertheless request the user to confirm backing-up of elements from said list to enable the user to choose the elements to be backed up with no risk of forgetting some elements.

The list can in practice also include an address of the environment data in the storage means, enabling the back-up program to access that data simply and efficiently.

The program can further include means for making its execution secure, such as means adapted to verify that a number entered by the user is identical to a number stored in an identification module. Instead of or in conjunction with such verification, there can additionally be provided a process of authentication between the electronic device and the electronic apparatus.

This ensures that backing-up is effected by the user who is the proprietor of the environment.

Means can be provided for determining the environment data to be backed up as a function of the type of electronic apparatus, for example by means of a table stored in the device, which enables the device to be used with more than one type of apparatus.

The program can execute said back-up itself when it is executed by the microprocessor; alternatively, the program can command installation in the electronic apparatus of a program for backing-up environment data in the device (for example by downloading at least a part of this program).

The invention also proposes an electronic apparatus including a microprocessor and means for storing environment data, the apparatus being adapted to be connected to a removable storage electronic device, characterized in that it includes means for authorizing, on connection of the device to the apparatus, execution by the microprocessor of a program stored in the electronic device and adapted to enable backing up of the environment data in the device.

The features referred to above in relation to the device can also be associated with the apparatus. The apparatus can also include means for restoring environment data backed up previously in the storage means.

The invention therefore additionally proposes a system comprising an electronic device connected to an electronic apparatus of this kind.

The invention thus proposes a method of backing-up in a storage electronic device environment data stored in electronic apparatus adapted to be connected to the device, characterized by the following steps:

transfer of a program stored in the electronic device to the electronic apparatus on connection of the device to the apparatus;

execution of the program by a microprocessor of the electronic apparatus; and

transfer and storage of the environment data in the electronic device as a consequence of an instruction of the program.

This method can include optional steps corresponding to the features of the device referred to above.

Other features and advantages of the invention will become more apparent in the light of the following description, given with reference to the appended drawings, in which:

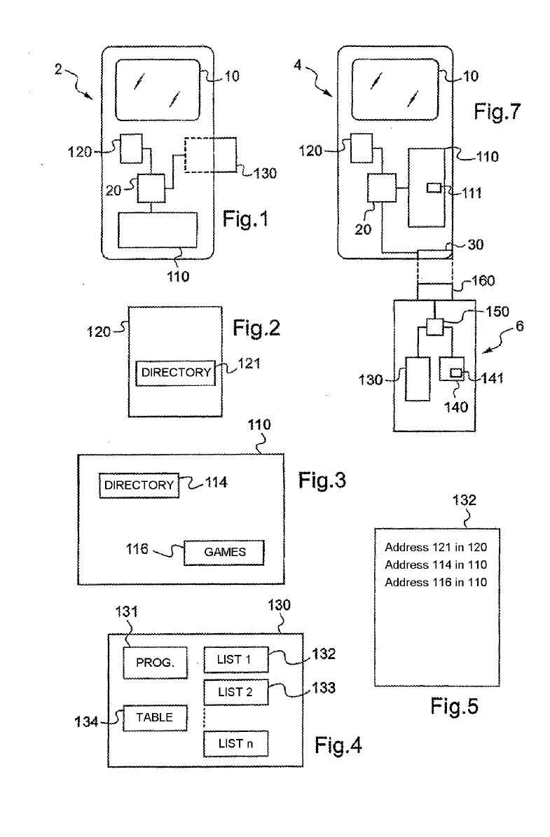

FIG. 1 represents diagrammatically the main elements of electronic apparatus receiving a removable storage device conforming to a first embodiment of the invention;

FIG. 2 represents diagrammatically an identification card of the electronic apparatus from FIG. 1;

FIG. 3 represents diagrammatically the content of a memory of the electronic apparatus from FIG. 1;

FIG. 4 represents diagrammatically the content of the removal storage device;

FIG. 5 shows one of the lists in the removable storage device from FIG. 4;

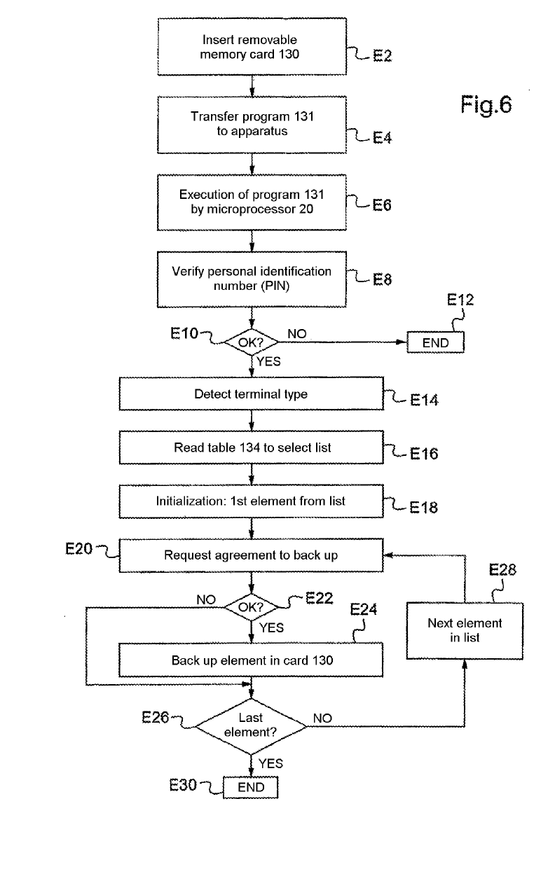

FIG. 6 shows the steps of the backing-up method proposed by the invention; and

FIG. 7 shows diagrammatically electronic apparatus and a storage device conforming to a second embodiment of the invention.

FIG. 1 represents the elements of electronic apparatus (here a cellular telephone 2) useful for understanding the invention.

Thus the cellular telephone 2 includes a screen 10 and a microprocessor 20 connected to a memory 110 of the telephone, to an identification module 120 (here an identification card, for example a subscriber identity module (SIM) card), and a removable memory card 130 forming a storage device.

The removable memory card 130 preferably includes a non-volatile rewritable memory, here a Flash memory. The removable memory card 130 is generally in a particular format (here the multimedia memory card (MMC) format) compatible with a reader (not shown) of the telephone into which the removable card 130 is inserted in FIG. 1.

FIG. 1 shows the various connections between the microprocessor 20 and each of the storage means (identification module 120, telephone memory 110, removable memory card 130) in the form of separate connections. Alternatively, all these elements could be connected to the microprocessor 20 by a common bus.

As shown diagrammatically in FIG. 2, the identification module 120 (here an SIM card) stores data and in particular data forming a directory 121 in which are associated data representing names and data representing telephone numbers.

As shown in FIG. 3, the memory 110 of the telephone also stores a directory 114 (also associating data representing telephone numbers and data representing names) and also data of other types (for example program data, in particular games program data 116), thanks to the greater capacity of this type of memory.

The removable memory card 130 stores an auto-run program 131 and a correspondence table 134 associating a list with each of a number of types of telephone; a number of lists 132, 133 are also stored in the removable memory card 130, as shown in FIG. 4.

The removable memory card 130 moreover contains these various elements before being inserted into the electronic apparatus (here the cellular telephone) in the manner shown in FIG. 1.

The program 131 is adapted to be executed by the microprocessor 20 of the telephone 2 and includes instructions that command backing-up of the personal data (including the contents of the directory 121, the directory 114 and the game programs 116 referred to above) in the memory of the removable memory card 130.

The microprocessor 20 and the removable memory card 130 are adapted to authorize transfer and then execution of the program 131 in the microprocessor 20 on insertion of the memory card 130 into the reader (not shown) of the FIG. 1 telephone. To this end, the program can for example be stored temporarily in the memory 110 of the telephone or in another memory (for example a random access memory) associated with the microprocessor 20.

As is described in more detail hereinafter, the program 131 is in particular able to consult the table 134 in order to determine, as a function of the type of telephone in which it is executed (which type is stored, for example, in an area of the memory 110 of the telephone or alternatively in an area of a read-only memory associated with the microprocessor 20), which of the lists stored in the removable memory card 130 must be used to determine the addresses of the personal data to be backed up in the various storage means of the telephone.

Accordingly, as shown in FIG. 5, the list 132 gives the address of the personal data for the telephone from FIGS. 1 to 3 (directory data 121 and 114, game programs 116) in each of the memories concerned (identification module 120 for the directory 121 and telephone memory 110 for the directory 114 and the game programs 116).

Using this list, and acting in accordance with the instructions contained in the program 131, the microprocessor 20 commands reading of the aforementioned personal data and then backing-up of that data in a dedicated area of the removable memory card 130 (i.e. writing that data via the reader, not shown).

FIG. 6 represents the steps of the method of backing-up personal data executed on insertion of the removable memory card 130 into the electronic apparatus 2 from FIG. 1.

When the removable memory card 130 is inserted (step E2) in the electronic apparatus (here the cellular telephone), to be more precise into the memory card reader included in the electronic apparatus 2, the program 131 stored in the removable memory card 130 is transferred into the electronic apparatus 2 in a step E4 and then automatically executed by the microprocessor 20 of the electronic apparatus (step E6).

In practice, this auto-run feature can be provided by storing the program 131 in the removable memory card 130 with a name and a position within the directory tree such that it is easily and automatically detected by the microprocessor 20 (for example in the root directory).

The personal data stored in the electronic apparatus 2 is backed up in the steps E8 to E30 described hereinafter and executed by virtue of the execution of the instructions contained in the program 131 by the microprocessor 20.

There follows in the step E8 the verification of the user's personal identification number (PIN), sometimes called their personal code, in collaboration with the identification module 120, of course.

The personal identification number is entered by the user on a keypad (not shown) of the electronic apparatus 2, for example.

If the code entered by the user is different from the personal identification number, the step E10 branches to a step E12 which terminates the backing-up of the data in order to prevent another user from being able to store the personal data of the bearer of the personal identification number.

On the other hand, if the code entered by the user matches the personal identification number, the step E10 branches to the steps E14 onwards that constitute the remainder of the backing-up procedure described hereinafter.

Although, for reasons of simplification, FIG. 6 shows a simple way to verify the personal identification number (referring explicitly to only one attempt to enter the correct code) the user can be allowed a number of attempts to enter the correct code.

If the correct code is entered in the step E14, the backing-up procedure continues with detection of the type of terminal used (i.e. detection of the type of electronic apparatus, here the cellular telephone), for example by the microprocessor 20 reading dedicated information in the telephone memory 110.

The microprocessor 20 then looks up in the table 134 stored in the removable memory card 130 the list associated with the type of terminal detected in the step E14 and selects that list (step E16) for subsequent processing (this list is one of the lists stored in the memory card 130 in the manner already explained).

The program 131 executed by the microprocessor 20 then uses a program loop to review the various elements of the list (each of which corresponds to one particular set of data that may have to be backed up) and proceeds to back up the data concerned, subject to the user's consent.

To this end, processing of the first element from the selected list is initialized in the step E18.

In the step E20 the microprocessor then dialogs with the user (by means of the screen 10, the user's response being received via the keypad already mentioned) in order to determine if the list element being processed must be backed up.

As a function of the user's response via the keypad (step E22), there follows or not a step E24 of backing-up the element being processed in the removable memory card 130. Note that to this end the list concerned indicates the address in the memory concerned of the data to be backed up, so that the data to be backed up can be read. The microprocessor then commands transfer of the data and storage thereof in an empty area of the removable memory card 130.

After the element concerned is backed up in the step E24 or after the user declines to back up that element following the step E22, the step E26 verifies if the element being processed is the last element in the list.

If not, the element concerned in the list is incremented in a step E28 and that element is processed from the step E20.

If so, all the elements from the list have been processed and the backing-up program can therefore be terminated in a step E30.

Data backed up in the removable memory card 130 can be restored in exactly the same way, i.e. automatically on inserting the removable memory card 130 into another electronic apparatus. To this end each electronic apparatus can store (for example in the telephone memory 110) an indicator specifying if the action effected on insertion of the removable card 130 should be to back up or to restore personal data. For example, the indicator stored during manufacture of the apparatus (i.e. the factory setting) commands backing-up on insertion of the card in order for that action to be the first one executed in the life of the apparatus.

Alternatively, insertion of the removable card 130 could systematically lead to backing-up the personal data by the process described above, the restoring of the data in an electronic apparatus from the removable card 130 being triggerable only at the request of the user, for example by the user selecting a restore command in an appropriate menu shown on the screen 10 of the apparatus.

A second embodiment of the invention is described next with reference to FIG. 7.

To simplify the explanation, the same reference numbers are used for elements identical to those of the first embodiment.

The electronic apparatus 4 used in this embodiment includes a connector 30, for example a USB connector, connected to the microprocessor 20.

The memory 130 that is to receive the backed-up data (which here does not take the form of a removable card) is part of a USB key type information medium 6, which also includes a secure microcontroller 140, a concentrator (or hub) 150, and a connector 160 adapted to be connected to the connector 30 of the apparatus 4.

The memory 130 contains the program 131 and the data described with reference to FIG. 4 in relation to the first embodiment.

When the user inserts the connector 160 of the device (here the key 6) into the connector 30 of the apparatus 4 (i.e. when they connect the device to the apparatus), the microprocessor 20 transfers and executes the program 131 stored in the memory 130, without the secure microcontroller preventing communication of the data forming the program 131.

The program 131 then launches in the microprocessor 20 a process of authentication with the secure microcontroller 140, for example by means of an exchange of cryptographic keys.

For example, the authentication process is effected by the microprocessor 20 executing an authentication program 111 stored in the telephone memory 110 that instigates dialog with the secure microcontroller 140, also under the control of an authentication program 141 executed in it, for example.

If, and only if, the microcontroller 140 is authenticated by the microprocessor 20, the program 131 commands backing-up of the environment data in the memory 130 of the key 6 as described above with reference to FIG. 1. Because of the preceding authentication step, however, the step of verifying the personal code of the first embodiment can be omitted.

As for the first embodiment, the backed-up data can be restored by the method described above. However, in the present context, in order to allow restoration only to authorized apparatus, it is proposed that the microcontroller 140 of the key 6 authenticate the microprocessor of the apparatus in which the data is to be restored (and not the other way round as was the case for backing-up).

In both cases (backing-up or restoration), an alternative is mutual authentication of the secure microcontroller and the microprocessor of the apparatus, rather than authentication of the one by the other.

These examples naturally constitute only possible embodiments of the invention.

1-33. (canceled)

34. A removable storage electronic device adapted to be connected to electronic apparatus including a microprocessor and means for storing environment data, the device including a program adapted to be executed automatically by the microprocessor on connection of the device to the apparatus in order to enable backing up of the environment data in the device.

35. An electronic device according to claim 34, storing a list indicating the environment data to be backed up.

36. An electronic device according to claim 35, wherein the program is adapted to demand confirmation of backing-up of the elements from said list when it is executed by the microprocessor.

37. An electronic device according to claim 34, wherein the program includes means for making its execution secure.

38. An electronic device according to claim 34, including means adapted to implement a process of authentication between the electronic device and the electronic apparatus.

39. An electronic device according to claim 34, wherein the program includes means for determining environment data to be backed up as a function of the type of electronic apparatus.

40. An electronic device according to claim 34, wherein the program is adapted to effect said backing-up when it is executed by the microprocessor.

41. An electronic apparatus including a microprocessor and means for storing environment data, the apparatus being adapted to be connected to a removable storage electronic device, the apparatus including means for authorizing, on connection of the device to the apparatus, execution by the microprocessor of a program stored in the electronic device and adapted to enable backing up of the environment data in the device.

42. An electronic apparatus according to claim 41, including means for reading in the electronic device a list indicating the environment data to be backed up.

43. An electronic apparatus according to claim 42, wherein the program is adapted to demand confirmation of backing-up of the elements from said list when it is executed by the microprocessor.

44. An electronic apparatus according to claim 42, wherein the list contains an address of the environment data in the storage means.

45. An electronic apparatus according to claim 41, wherein the program includes means for making its execution secure.

46. An electronic apparatus according to claim 41, including means for restoring in the storage means environment data backed up beforehand.

47. A system including an electronic device according to claim 34 connected to said electronic apparatus including said microprocessor and said means for storing environment data, the apparatus being adapted to be connected to a removable storage electronic device, the apparatus including means for authorizing, on connection of the device to the apparatus, execution by the microprocessor of said program stored in the electronic device and adapted to enable backing up of the environment data in the device.

48. A method of backing-up in a storage electronic device environment data stored in an electronic apparatus adapted to be connected to the device, characterized by the following steps:
transfer of a program stored in the electronic device to the electronic apparatus on connection of the device to the apparatus;
execution of the program by a microprocessor of the electronic apparatus; and
transfer and storage of the environment data in the electronic device as a consequence of an instruction of the program.

49. An electronic device according to claim 35, wherein the program is adapted to effect said backing-up when it is executed by the microprocessor.

50. An electronic device according to claim 36, wherein the program is adapted to effect said backing-up when it is executed by the microprocessor.

51. An electronic device according to claim 37, wherein the program is adapted to effect said backing-up when it is executed by the microprocessor.

52. An electronic device according to claim 38, wherein the program is adapted to effect said backing-up when it is executed by the microprocessor.

53. An electronic device according to claim 39, wherein the program is adapted to effect said backing-up when it is executed by the microprocessor.
